(19) United States
(12) Patent Application Publication
(10) Pub. No.: US 2012/0086694 A1
(43) Pub. Date: Apr. 12, 2012

(54) PIXEL CIRCUIT AND DISPLAY PANEL WITH IR-DROP COMPENSATION FUNCTION

(75) Inventors: Szu-Heng TSENG, Hsin-Chu (TW); Tze-Chien Tsai, Hsin-Chu (TW)

(73) Assignee: AU OPTRONICS CORP., Hsinchu (TW)

(21) Appl. No.: 13/098,576

(22) Filed: May 2, 2011

(30) Foreign Application Priority Data
Oct. 8, 2010 (TW) 099134462

(51) Int. Cl. G09G 5/00

(52) U.S. Cl. 345/212

(57) ABSTRACT

A pixel circuit and a display panel with an IR-drop compensation function are disclosed. The display panel includes multiple pixel circuits and multiple compensation circuits. Each of the pixel circuits includes a detecting switch. After a real work voltage of a pixel circuit is transmitted to a corresponding compensation circuit through a corresponding detecting switch, a data transmitted to the pixel circuit is adjusted by the compensation circuit according to a relationship between the real work voltage and an original work voltage.

### FIELD OF THE INVENTION

The present invention relates to pixel circuits and display panels, and more particularly to a pixel circuit and a display panel with an IR-drop (internal-resistance drop) compensation function.

### BACKGROUND OF THE INVENTION

OLEDs (Organic light emitting diode) have characteristics of thin thickness, light weight, self-illumination, low drive voltage, high efficiency, high contraction, high color saturation and high response speed. After the TFT (Thin Film Transistor), the OLEDs are known as the most promising and new display technique.

FIG. 1 is a diagram of a conventional OLED display 10. The OLED display 10 includes N*M pixel circuits which are electrically coupled to a current-supply line I from which an original work voltage OVDD can be supplied to each of the N*M pixel circuits. Moreover, the N pixel circuits arranged in a same row are electrically coupled to a same control line; for example, the N pixel circuits (1,1), (1,2), . . . , (1,N) in the first row are electrically coupled to the control line SCAN-1. Moreover, the M pixel circuits arranged in a same column is electrically coupled to a same data line; for example, the M pixel circuits (1,1), (2,1), . . . , (M,1) in the first column are electrically coupled to the data line DATA-1 from which the data voltage V_{data1} can be supplied to each of the M numbers of the pixel circuits (1,1), (2,1), . . . , (M,1). In the OLED display 10, the active of the pixel circuit is controlled by its corresponding control line. Moreover, the light intensity of the pixel circuit is related to a driving current which is flowing through the pixel circuit; wherein the driving current is created from the original work-voltage level OVDD which is provided from the current-supply line I, and the intensity of the driving current of the pixel circuit is controlled by its corresponding data line.

FIG. 2 is a circuit diagram of a pixel circuit in the conventional OLED display 10. As depicted in FIG. 2, the pixel circuit 20 mainly includes a first transistor switch T1, a second transistor switch T2, a capacitor C1 and an OLED. The control end of the first transistor switch T1 is electrically coupled to the control line SCAN; the first channel end of the first transistor switch T1 is electrically coupled to the data line DATA to receive a data voltage V_{data} from the data line DATA; one end of the capacitor C1, the second channel end of the first transistor switch T1 and the control end of the second transistor switch T2 are electrically coupled to a data-store node P; the other end of the capacitor C1 and the first channel end of the second transistor switch T2 are electrically coupled to the current-supply line I to receive the original work-voltage OVDD from the current-supply line I; the second channel end of the second transistor switch T2 is electrically coupled to the first end of the OLED; and the second end of the OLED is grounded.

As depicted in FIG. 2, the establishment of the electrical conduction between the first and second channel ends of the first transistor switch T1 is controlled by the control line SCAN; in other words, the first transistor switch T1 is electrically conductive within an enable period of the control line SCAN (the control line is at a relatively low voltage level within its enable period when the first transistor switch T1 is a p-type transistor). When the first transistor switch T1 is electrically conductive, the data voltage V_{data}, supplied from the data line DATA to the first channel end of the first transistor switch T1, is written to the capacitor C1. Because a voltage difference is created between the two ends of the capacitor C1 written with the data voltage V_{data}, the second transistor switch T2 is accordingly electrically conductive so as the driving current, originally supplied from the current-supply line I, is flowed to the OLED via the conductive second transistor switch T2, thereby light is emitted from the OLED. In the pixel circuit 20, the intensity of the driving current flowing through the OLED is obtained by equation: I_{OLED}=K(OVDD−Vdata−|Vₜₕ|)²; wherein I_{OLED} is the driving current flowing through the OLED, K is a constant, Vₜₕ is the threshold voltage of the second transistor switch T2.

In theory, the work voltage transmitted from the current-supply line I to each pixel circuit has a fixed value OVDD, as shown in FIG. 1 and FIG. 2. However, because the current-supply line I has a line resistance which may cause an IR-drop, the real work voltage actually transmitted to the multiple pixel circuits from the current-supply line I can not be fixed at OVDD. For example, as depicted in FIG. 3, the work voltage supplied to the first pixel circuit 30 from the current-supply line I is the original work-voltage OVDD; while, the work-voltage actually supplied to the second pixel circuit 32 is down to OVDD due to the IR-drop. Because the first pixel circuit 30 gets the original work voltage OVDD but the second pixel circuit 32 gets the real work voltage OVDD′, the driving current flowing through the OLED of the first pixel circuit 30 is different from that of the second pixel circuit 32, even both the first pixel circuit 30 and the second pixel circuit 32 receive the data voltage V_{data} with a same value from the data line DATA, thereby the light intensity emitted from the first pixel circuit 30 is different from the light intensity emitted from the second pixel circuit 32.

Assuming the multiple pixel circuits in a conventional OLED display panel plan are needed to play a same color, that is the multiple pixel circuits have a same value of the data voltage V_{data}, these multiple pixel circuits may still get different driving currents because these multiple pixel circuits get different actual work voltages due to the IR-drop, accordingly an uneven brightness may be generated by these multiple pixel circuits. Therefore, how to compensate the IR-drop so as to reduce the effect on the LED display panel is an issue to be solved.

### SUMMARY OF THE INVENTION

Therefore, the object of the present invention is to provide a pixel circuit and a display panel with an IR-drop compensation function, so that the brightness uniformity of the display panel is increased.

An embodiment of the present invention provides a pixel circuit electrically coupled to a current-supply line, at least a control line and a data line which is for providing data. The pixel circuit comprises: a current-driven device comprising a first end and a second end, wherein a light is emitted from the current-driven device while a current is flowing through the current-driven device from the first end to the second end; a current-control circuit for receiving data from the data line and storing the received data as driving data according to the voltage level of a first control line, receiving a real work voltage from the current-supply line, and controlling the current intensity flowing to the current-driven device via the current-control circuit from the current-supply line according to the driving data; and a detecting switch comprising a control end, a first channel end and a second channel end, wherein the first channel end of the detecting switch is electrically coupled to the current-control circuit and is used for retrieving the real work voltage, the control end of the detecting switch is electrically coupled to a second control line and is used for determining the electrical conduction between the first and the second channel ends of the detecting switch.

In one embodiment, the above mentioned current-control circuit comprises: a first switch comprising a control end, a first channel end and a second channel end, wherein the control end of the first switch is electrically coupled to the first control line, the first channel end of the first switch is electrically coupled to the data line; a capacitor, wherein one end of the capacitor and the second channel end of the first switch are both electrically coupled to a data-store node, and the other end of the capacitor is electrically coupled to the current-supply line; and a second switch comprising a control end, a first channel end and a second channel end, wherein the control end of the second switch is electrically coupled to the data-store node, the first channel end of the second switch is electrically coupled to the current-supply line and the second channel end of the second switch is electrically coupled to the first end of the current-driven device.

In one embodiment, the above mentioned first control line and the second control is a same control line.

In one embodiment, the above mentioned the first control line and the second control line are used for transmitting two different time-sequence signals, the enable period of the time-sequence signal transmitted by the first control line is after the enable period of the time-sequence signal transmitted by the second control line, without overlap there.

In one embodiment, the above mentioned second channel end of the detecting switch is electrically coupled to the data line.

Another embodiment of the present invention provides a display panel comprising: a plurality of data lines; a plurality of control lines; a plurality of power-supply lines; a plurality of pixel circuits, each of the pixel circuits is electrically coupled to at least one of the control lines, one of the power-supply lines and one of the data lines, and each of the pixel circuits comprising: a current-driven device comprising a first end and a second end, wherein a light is emitted from the current-driven device while a current is flowing through the current-driven device from the first end to the second end; a current-control circuit for receiving data from the data line and storing the received data as driving data according to the voltage level of a first control line, receiving a real work voltage from the current-supply line, and controlling the current intensity flowing to the current-driven device via the current-control circuit from the current-supply line according to the driving data; and a detecting switch comprising a control end, a first channel end and a second channel end, wherein the first channel end of the detecting switch is electrically coupled to the current-control circuit and is used for retrieving the real work voltage, the control end of the detecting switch is electrically coupled to a second control line and is used for determining the electrical conduction between the first and the second channel ends of the detecting switch; and a plurality of compensation circuits, wherein the second channel end of the detecting switch of each of the pixel circuits is electrically coupled to a corresponding compensation circuit, and the corresponding compensation circuit is for modulating the data received from the data line which is electrically coupled to a corresponding pixel circuit according to a relationship between an original work voltage and the voltage received from the second channel end of the detecting switch.

In one embodiment, the above mentioned display panel further comprises: a plurality of switching unit, wherein each of the switching units is corresponding to one of the data lines and one of the compensation circuit, and each of the switching units can be switched to make its corresponding data line electrical coupled to either the output end or the input end of the corresponding compensation circuit.

In one embodiment, each of the above mentioned compensation circuit comprises: a voltage-reader unit comprising an input end and an output end, wherein the input end of the voltage-reader unit is electrically coupled to its corresponding detecting switch and the voltage-reader unit is user for reading and outputting the voltage at the corresponding detecting switch; and a comparing unit, electrically coupled to the output end of the voltage-reader unit, for computing a difference through comparing the voltage at the output end of the voltage-reader unit and the original work voltage, and modulating the data of the corresponding data line according to the difference.

In the pixel circuit and the display panel with the IR-drop function of the present invention, the effect of the line resistance of the current-supply line on the current flowing through the current-driven device can be eliminated through compensating the data at the data line by a difference value between the real work voltage and the original work voltage.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 is a circuit diagram of a conventional OLED display panel;

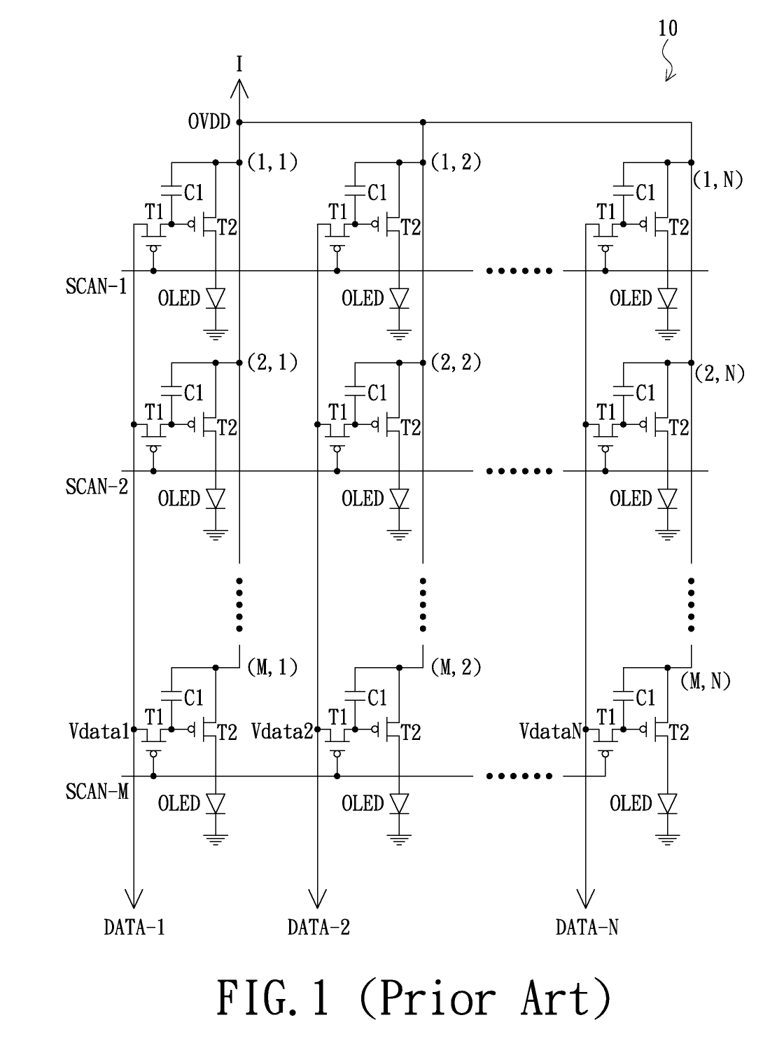

FIG. 2 is a circuit diagram of a pixel circuit of the conventional OLED display;

FIG. 3 is a circuit diagram of two adjacent pixel circuits of the conventional OLED display;

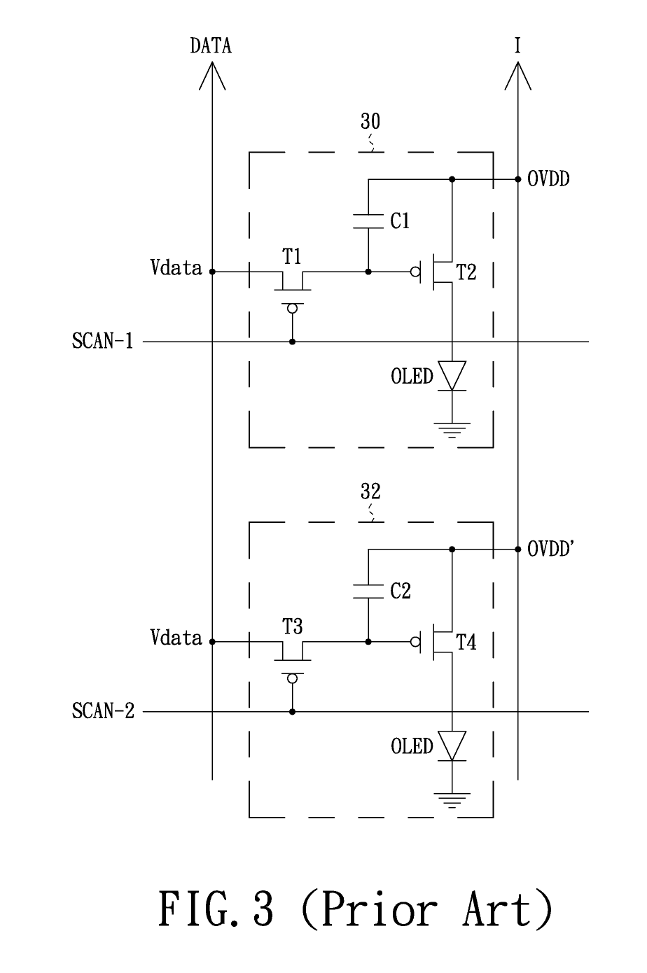

FIG. 4 is a circuit diagram of a display panel with an IR-drop compensation function in one embodiment of the present invention;

FIG. 5 is a circuit diagram of a display panel with an IR-drop compensation function in another embodiment of the present invention; and

FIG. 6 is a circuit diagram of a pixel circuit with an IR-drop compensation function and its corresponding compensation circuit in one embodiment of the present invention.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

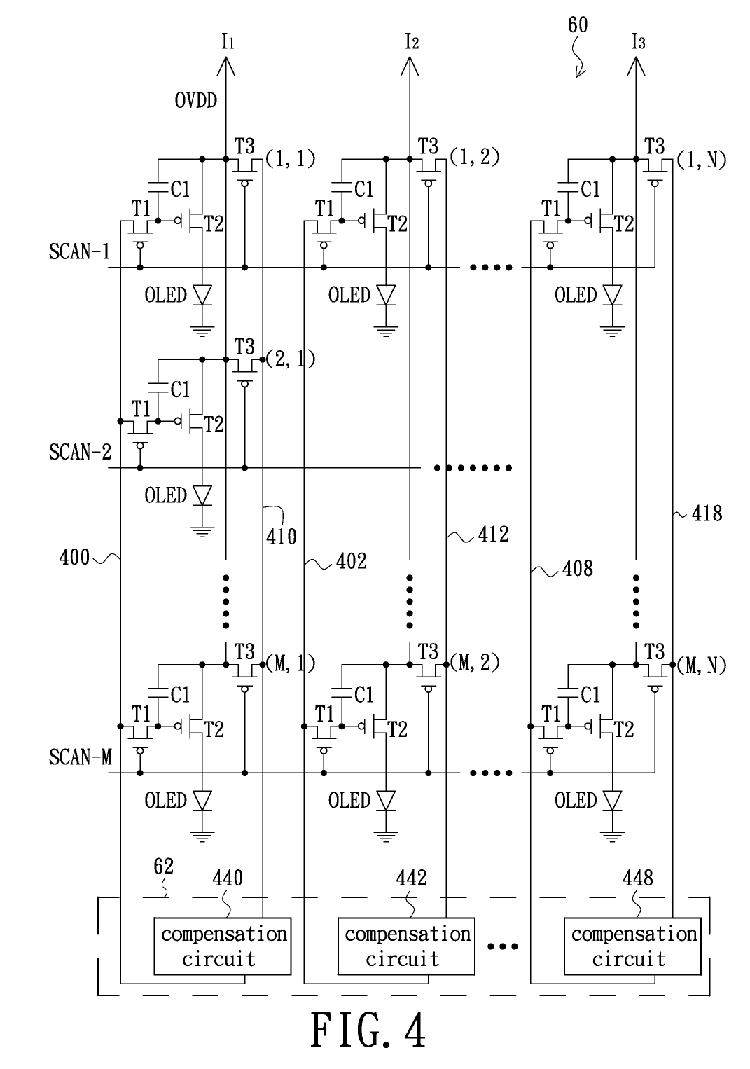

FIG. 4 is a circuit diagram of a LED display panel with an IR-drop compensation function in an embodiment of the present invention. As depicted in FIG. 4, the LED display panel 60 includes multiple data lines 400, 402 . . . 408, multiple control lines SCAN-1, SCAN-2 . . . SCAN-M, multiple power-supply lines I, I₂ . . . I₃, multiple compensation circuits 440, 442 . . . 448 and multiple pixel circuits (1,1), (1,2) . . . (M,N). As depicted in FIG. 4, the control ends of both the first transistor switches T1 and the detecting switches T3 of the N pixel circuits, such as, (1,1), (1,2) . . . (1,N) in a same row, are electrically coupled to a same control line, such as SCAN-1; the second channel ends of the detecting switches T3 of the M pixel circuits such as, (1,1), (2,1) . . . (M,1), in a same column, are electrically coupled to an input end of a same compensation circuit, such as, compensation circuit 440, via a data-reader line, such as, data-reader line 410; additionally, the first channel ends of the detecting switches T3 of the M pixel circuits, such as, (1,1), (2,1) . . . (M,1) in a same column, is electrically coupled to a current-supply line such as, current-supply line I_{I}; and the first channel ends of the first transistor switches T1 of the M pixel circuits, such as, (1,1), (2,1) . . . (M,1), in a same column, is electrically coupled to an output end of a same compensation circuit, such as, compensation circuit 440.

The main function of each compensation circuit is for modulating the data on a data line, such as, data line 402, electrically coupled to a corresponding pixel circuit, such as, pixel circuit (M,2), based on a difference-value relationship between the real work voltage OVDD′ actually supplied to the detecting switch T3 of the corresponding pixel circuit from the current-supply line and the original work voltage OVDD supplied from the source of the current-supply line, so that the compensation to the driving current flowing through the OLED of the corresponding pixel circuit is realized, thereby the effect on the driving current because of the difference value between the real work voltage OVDD′ and the original work voltage OVDD is eliminated. It is understood that the multiple compensation circuits 440, 442 . . . 448 can be arrange in any place, for example, the multiple compensation circuits 440, 442 . . . 448 can be arranged in a Source IC 62 in the embodiment, as depicted in FIG. 4.

For example, within the enable period of the control line SCAN-2, the real work voltage OVDD′ actually received by the pixel circuit (2,1) from the current-supply line I₁ is further transmitted to the compensation circuit 440 sequentially via the conductive detecting switch T3 and the data-reader line 410. Within a same enable period of the control line SCAN-2, a compensated data voltage V_{data1}′ is created and outputted from the compensation circuit 440 according to the difference value between the real work voltage OVDD′ which is supplied to the pixel circuit (2,1) and the original work voltage OVDD which is supplied from the source of the current-supply line L. The compensated data voltage V_{data1}′ is transmitted to the data line 402 which is electrically coupled to the pixel circuit (2,1), that is, the compensated data voltage V_{data1}′ is transmitted to the first channel end of the first transistor switch T1 of the pixel circuit (2,1), so that the modulation of the driving current flowing through the OLED of the pixel circuit (2,1) is realized.

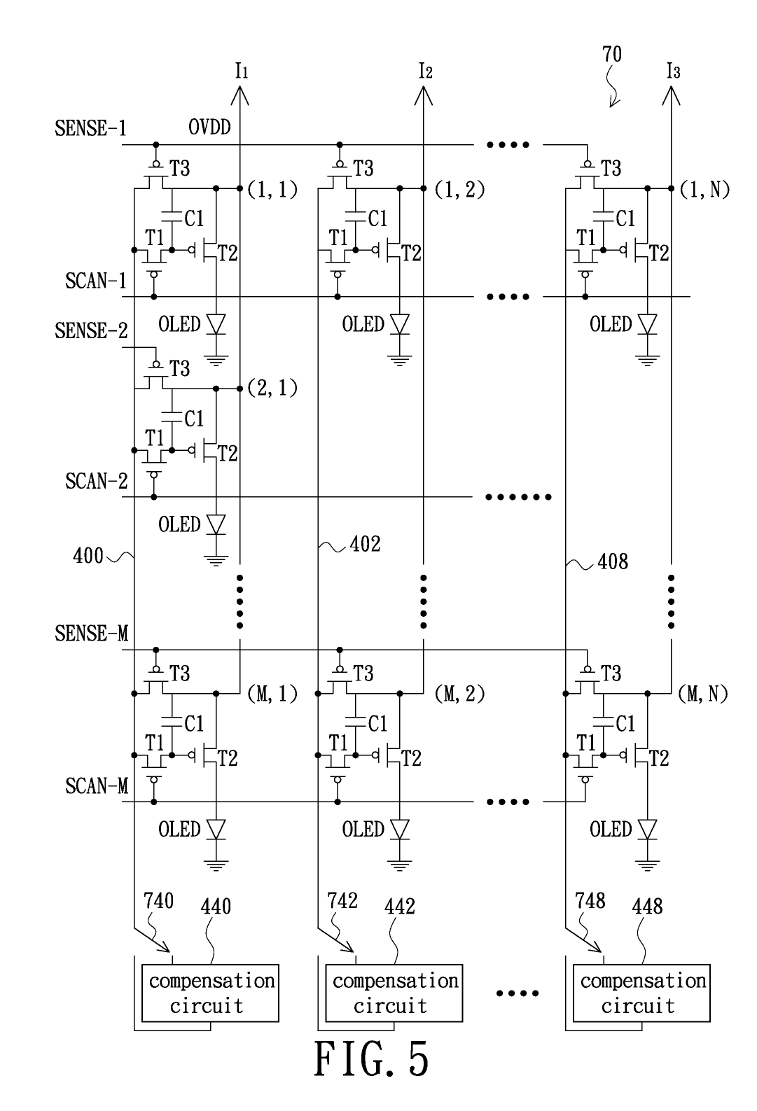

FIG. 5 is a circuit diagram of a LED display panel 70 with an IR-drop compensation function in another embodiment of the present invention. The main difference between the FIG. 4 and FIG. 5 is that the function of the data-reader lines 410˜418 in the embodiment of FIG. 4 is integrated to the corresponding data lines 400˜408 in the embodiment of FIG. 5. To achieve a same function provided by the embodiment depicted in FIG. 4, each of the data lines 400˜408 in FIG. 5 is capable of either providing data to the corresponding compensation circuits 440˜480 or receiving data from the corresponding compensation circuits 440˜480 based on an operation of the corresponding switch units 740˜748. Moreover, because the first transistor switch T1 and the detecting switch T3 in each of the pixel circuits are necessarily to be conductive in different periods, accordingly the first transistor switch T1 and the detecting switch T3 in each of the pixel circuits are individually controlled by two different control lines.

Specifically, as depicted in FIG. 5, the control ends of the first transistor switches T1 of the N pixel circuits, such as, (1,1), (1,2) . . . (1,N) in a same row are electrically coupled to a same first control line (i.e., SCAN-1); and the control ends of the detecting switches T3 of the N pixel circuits, such as, (1,1), (1,2) . . . (1,N) arranged in a same row are electrically coupled to a same second control line, such as, SENSE-1. Moreover, the first channel ends of the detecting switches T3 of the M pixel circuits, such as, (1,1), (2,1) . . . (M,1) arranged in a same column are electrically coupled to a same current-supply line, such as, current-supply line I₁; and the second channel ends of the detecting switches T3 and the first channel ends of the first transistor switches T1 of the M pixel circuits, such as, (1,1), (2,1) . . . (M,1) arranged in a same column are electrically coupled to a first end of a same switch unit, such as, switch unit 740. The second end of each switch unit can be switched to either the input end or the output end of its corresponding compensation circuit; wherein the second end of each switch unit is switched to the input end of the corresponding compensation circuit within an enable period of the second control line and is switched to the output end of the corresponding compensation circuit within an enable period of the first control line.

Give pixel circuit (2,1) as an example, the second end of the switch unit 740 is switched to the input end of the compensation circuit 440 within an enable period of the second control line SENCE-2 which is electrically coupled to the pixel circuit (2,1). The real work voltage OVDD′ actually received by the pixel circuit (2,1) from the current-supply line I is further transmitted to the compensation circuit 440 sequentially via the conductive detecting switch T3, the data line 400 and the switch unit 740. Afterward, the second end of the switch unit 740 is switched to the output end of the compensation circuit 440 within an enable period of the first control line SCAN-2 which is electrically coupled to the pixel circuit (2,1), accordingly the compensated data voltage V_{data1}′, based on the difference value between the real work voltage OVDD′ actually received by the pixel circuit (2,1) and the original work voltage OVDD within the previous enable period, is outputted from the compensation circuit 440 to the data line 400, so that the modulation of the driving current flowing through the OLED in the pixel circuit (2,1) is realized.

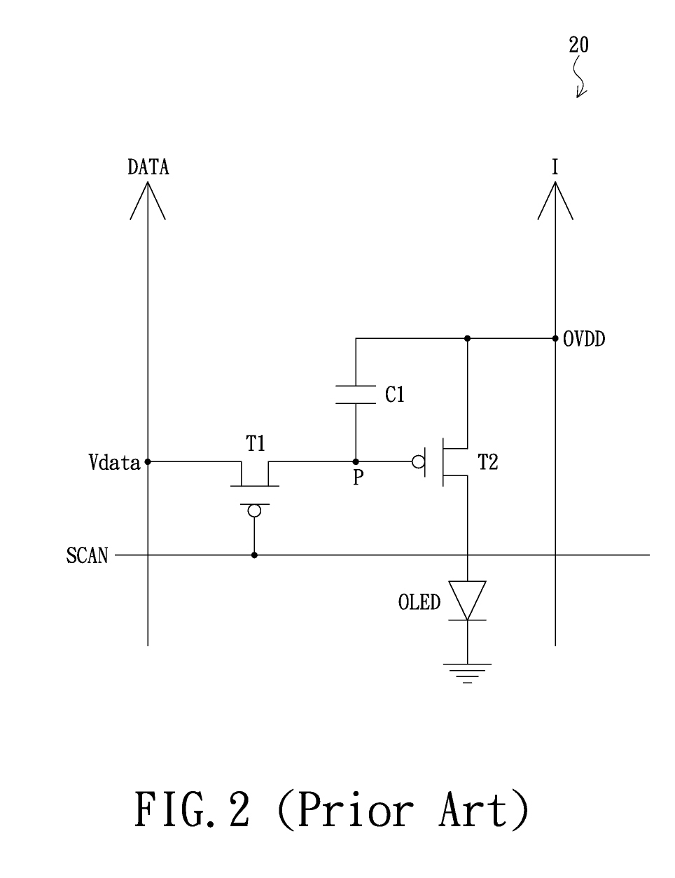

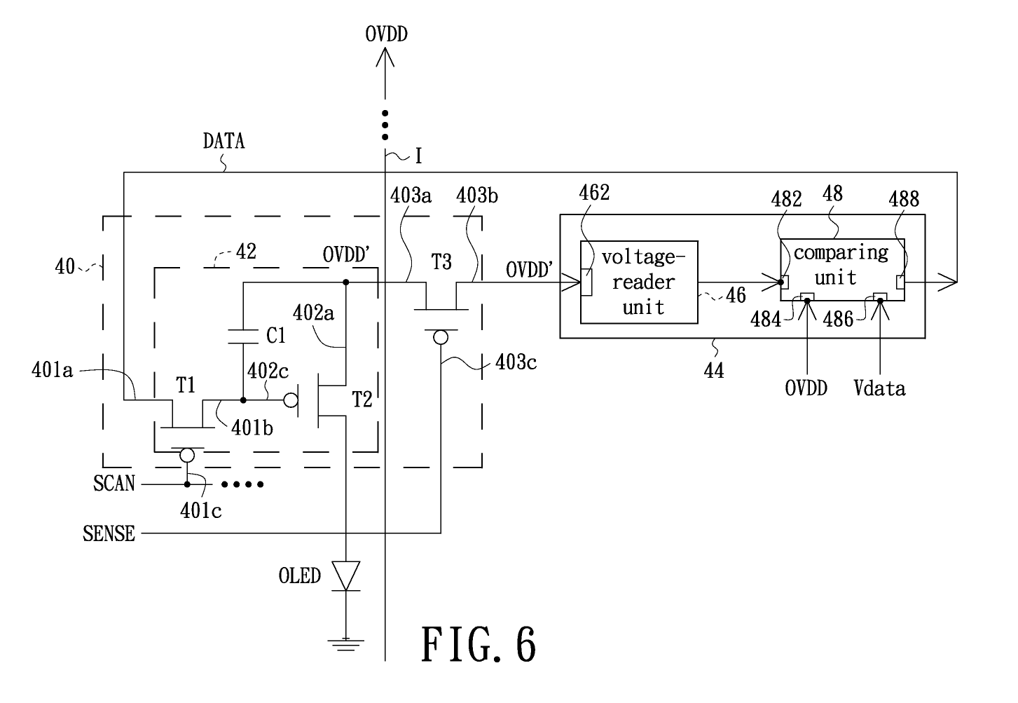

FIG. 6 is a circuit diagram of a pixel circuit with the IR-drop function and its corresponding compensation circuit in one embodiment. As depicted in FIG. 6, the pixel circuit 40 arranged in the present invention mainly includes a current-control circuit 42, an OLED and a detecting switch T3. The current-control circuit 42 mainly includes a first transistor switch T1, a second transistor switch T2 and a capacitor C1. In the pixel circuit 40 of the present invention, because the connecting structures between the first transistor switch T1, the second transistor switch T2, the capacitor C1 and the OLED are same as those in the conventional pixel circuit 20 depicted in FIG. 2, there is no any unnecessary detail is given here. The control end 401c of the first transistor switch T1 is electrically coupled to the first control line SCAN which is used for controlling the electrical conduction of the first channel end 401a and the second channel end 401b of the first transistor switch T1; in other words, the first transistor switch T1 is electrically conductive within an enable period of the first control line SCAN. The first channel end 402a of the second transistor switch T2 is electrically coupled to the current-supply line I from which the real work voltage OVDD′ is received; wherein the intensity of the real work voltage OVDD′ is different to the original work voltage OVDD which is supplied from the source of the current-supply line I due to the line resistance, as mentioned above. The control end 403c of the detecting switch T3 is electrically coupled to the second control line SENSE which is used for controlling the electrical conduction of the first channel end 403a and the second channel end 403b of the detecting switch T3; in other words, the detecting switch T3 is electrically conductive within an enable period of the second control line SENSE. The first channel end 403a of the detecting switch T3 is electrically coupled to the current-supply line I from which the real work voltage OVDD′ is received.

As depicted in FIG. 6, the second channel end 403b of the detecting switch T3 is electrically coupled to the compensation circuit 44. The compensation circuit 44 includes a voltage-reader unit 46 and a comparing unit 48. The input end 462 of the voltage-reader unit 46 i.e., the input end of compensation unit 44, is electrically coupled to the second channel end 403b of the detecting switch T3, and the output end of the voltage-reader unit 46 is electrically coupled to the first input end 482 of the comparing unit 48. Moreover, the original work voltage OVDD and the data voltage V_{data} on the data line DATA are inputted to the comparing unit 48 via the second input end 484 and the third input end 486, respectively. The output end of the compensation circuit 44 i.e., the output end 488 of the comparing unit 48, is electrically coupled to the first channel end 401a of the first transistor switch T1.

In an embodiment, an electrical conduction is established between the first channel end 403a and the second channel end 403b of the detecting switch T3 within an enable period of the second control line SENSE, so that the real work voltage OVDD′, received by the first channel end 403a of the detecting switch T3, is further transmitted to the input end of the voltage-reader unit 46. The voltage-reader unit 46 can be designed as a high input-impedance device, so that the voltage on the input end 462 of the voltage-reader unit 46 is extremely close to the real work voltage OVDD′ on the first channel end 403a of the detecting switch T3. The comparing unit 48 is used to compute the difference value between the real work voltage OVDD′ and the original work voltage OVDD, so that the corresponding data voltage V_{data} on the data line DATA can be accordingly modulated based on the difference values between the real work voltage OVDD′ and the original work voltage OVDD. In other words, after the real work voltage OVDD′, the original work voltage OVDD and the data voltage V_{data} on the data line DATA are inputted to the comparing unit 48, the compensated data voltage V_{data}′ is accordingly obtained based on the equation Vdata′=Vdata−(OVDD−OVDD′) and is then transmitted to the first channel end 401a of the first transistor switch T1 from the data line DATA. The compensated data voltage V_{data}′ is further transmitted to the current-control unit 42 via the conductive first transistor switch T1 within an enable period of the control line SCAN. Afterwards, the driving current flowing through the OLED is modulated to a correct value I_{OLED}=K(OVDD−Vdata−|Vₜₕ|)² according to the equations of

I_{OLED}=K(OVDD′−Vdata′−|Vₜₕ|)²

Vdata′=Vdata−(OVDD−OVDD′).

As mentioned above, because the voltage-reader unit 46 is a high input-impedance device, the voltage-reader unit 46 can be implemented by a buffer with operational amplifier (OP) or other voltage detector unit with a high input-impedance (input current is close to 0).

Moreover, the comparing unit 48 can be implemented by multiple analog potential comparators, or multiple analog difference amplifiers achieved by operational amplifiers, or any other devices having the same function as a analog difference amplifier has.

Moreover, the first control line SCAN and the second control line SENSE can be implemented by two different control lines for delivering two different time-sequence signals or a single control line. For example, as depicted FIG. 5, the first control line SCAN and the second control line SENSE are implemented by two different control lines for delivering two different time-sequence signals. When the first control line SCAN and the second control line SENSE are two different control lines, there is no specific requirement to the time-sequence relationship between the enable periods of the first control line SCAN and the second control line SENSE, the only thing needs to be concerned is that the compensation to the present data is based on the data related to the previous frame or the present frame. However, it makes much less impact on the present date whether the compensation to the present data is based on the data related to the previous frame or the present frame, because the line resistance is not changed a lot within adjacent multiple frames.

For example, the enable period of the first control line SCAN can appear after the enable period of the second control line SENSE, without overlap there between, wherein the enable periods of the two control lines have a relatively low voltage because the first transistor switch T1 and the detecting switch T3 are implemented by P-type transistors. So, the detecting switch T3 is conductive firstly, and an adjusting amount for compensating the image data of the data line is calculated. After the adjusting amount is calculated, the adjusting amount can be added to the incoming image data on the corresponding data line, thereby the image data is compensated. Or, in another embodiment as depicted in FIG. 4, the electrical conductions of first transistor switch T1 and the detecting switch T3 can be conductive simultaneously and controlled by a same control line. The calculated adjusting amount can be used to the compensation of the present image data, or, the compensation of the incoming image data. It is understood that it is not necessary to adopt the IR-drop compensation of the present invention to every single frame, the IR-drop compensation of the present invention can be executed when the user or designer prefers to. Moreover, the calculated adjusting amount can be recorded for the next compensation of the image data.

To sum up, in the pixel circuit and the display panel with the IR-drop function of the present invention, the effect of the line resistance of the current-supply line on the current flowing through the current-driving device can be eliminated through compensating the data at the data line by a difference value between the real work voltage and the original work voltage.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A pixel circuit electrically coupled to a current-supply line, at least a control line and a data line which is for providing data, the pixel circuit comprising:
a current-driven device comprising a first end and a second end, wherein a light is emitted from the current-driven device while a current is flowing through the current-driven device from the first end to the second end;
a current-control circuit for receiving data from the data line and storing the received data as driving data according to the voltage level of a first control line, receiving a real work voltage from the current-supply line, and controlling the current intensity flowing to the current-driven device via the current-control circuit from the current-supply line according to the driving data; and
a detecting switch comprising a control end, a first channel end and a second channel end, wherein the first channel end of the detecting switch is electrically coupled to the current-control circuit and is used for retrieving the real work voltage, the control end of the detecting switch is electrically coupled to a second control line and is used for determining the electrical conduction between the first and the second channel ends of the detecting switch.

2. The pixel circuit according to claim 1, wherein the current-control circuit comprises:
a first switch comprising a control end, a first channel end and a second channel end, wherein the control end of the first switch is electrically coupled to the first control line, the first channel end of the first switch is electrically coupled to the data line;
a capacitor, wherein one end of the capacitor and the second channel end of the first switch are both electrically coupled to a data-store node, and the other end of the capacitor is electrically coupled to the current-supply line; and
a second switch comprising a control end, a first channel end and a second channel end, wherein the control end of the second switch is electrically coupled to the data-store node, the first channel end of the second switch is electrically coupled to the current-supply line and the second channel end of the second switch is electrically coupled to the first end of the current-driven device.

3. The pixel circuit according to claim 1, wherein the first control line and the second control is a same control line.

4. The pixel circuit according to claim 1, wherein the first control line and the second control line are used for transmitting two different time-sequence signals, the enable period of the time-sequence signal transmitted by the first control line is after the enable period of the time-sequence signal transmitted by the second control line, without overlap there.

5. The pixel circuit according to claim 4, wherein the second channel end of the detecting switch is electrically coupled to the data line.

6. A display panel, comprising:
a plurality of data lines;
a plurality of control lines;
a plurality of power-supply lines;
a plurality of pixel circuits, each of the pixel circuits is electrically coupled to at least one of the control lines, one of the power-supply lines and one of the data lines, and each of the pixel circuits comprising:
a current-driven device comprising a first end and a second end, wherein a light is emitted from the current-driven device while a current is flowing through the current-driven device from the first end to the second end;
a current-control circuit for receiving data from the data line and storing the received data as driving data according to the voltage level of a first control line, receiving a real work voltage from the current-supply line, and controlling the current intensity flowing to the current-driven device via the current-control circuit from the current-supply line according to the driving data; and
a detecting switch comprising a control end, a first channel end and a second channel end, wherein the first channel end of the detecting switch is electrically coupled to the current-control circuit and is used for retrieving the real work voltage, the control end of the detecting switch is electrically coupled to a second control line and is used for determining the electrical conduction between the first and the second channel ends of the detecting switch; and
a plurality of compensation circuits, wherein the second channel end of the detecting switch of each of the pixel circuits is electrically coupled to a corresponding compensation circuit, and the corresponding compensation circuit is for modulating the data received from the data line which is electrically coupled to a corresponding pixel circuit according to a relationship between an original work voltage and the voltage received from the second channel end of the detecting switch.

7. The display panel according to claim 6, wherein the current-control circuit comprises:
a first switch comprising a control end, a first channel end and a second channel end, wherein the control end of the first switch is electrically coupled to the first control line, the first channel end of the first switch is electrically coupled to its corresponding data line;
a capacitor, wherein one end of the capacitor and the second channel end of the first switch are both electrically coupled to a data-store node, and the other end of the capacitor is electrically coupled to its corresponding current-supply line; and
a second switch comprising a control end, a first channel end and a second channel end, wherein the control end of the second switch is electrically coupled to the data-store node, the first channel end of the second switch is electrically coupled to its corresponding current-supply line and the second channel end of the second switch is electrically coupled to the first end of the current-driven device.

8. The display panel according to claim 6, wherein the first control line and the second control is a same control line.

9. The display panel according to claim 6, wherein the first control line and the second control line are used for transmitting two different time-sequence signals, the enable period of the time-sequence signal transmitted by the first control line is appeared after the enable period of the time-sequence signal transmitted by the second control line, and there is no overlap between the enable periods of the time-sequence signals transmitted by the first and the second control lines.

10. The display panel according to claim 9, wherein second channel end of the detecting switch is electrically coupled to the data line.

11. The display panel according to claim 10, further comprising:
a plurality of switching unit, wherein each of the switching units is corresponding to one of the data lines and one of the compensation circuit, and each of the switching units can be switched to make its corresponding data line electrical coupled to either the output end or the input end of the corresponding compensation circuit.

12. The display panel according to claim 6, wherein each of the compensation circuit comprises:
a voltage-reader unit comprising an input end and an output end, wherein the input end of the voltage-reader unit is electrically coupled to its corresponding detecting switch and the voltage-reader unit is user for reading and outputting the voltage at the corresponding detecting switch; and
a comparing unit, electrically coupled to the output end of the voltage-reader unit, for computing a difference through comparing the voltage at the output end of the voltage-reader unit and the original work voltage, and modulating the data of the corresponding data line according to the difference.
